(19) United States
(12) Patent Application Publication
(10) Pub. No.: US 2008/0244730 A1
(43) Pub. Date: Oct. 2, 2008

(54) SECURITY CAPABILITY WITH AN INPUT DEVICE

(75) Inventors: Wai-leung Ha, Hong Kong (CN); Kairy Kai Lei, Shen Zhen City (CN)

Correspondence Address: BANNER & WITCOFF, LTD., TEN SOUTH WACKER DRIVE, SUITE 3000, CHICAGO, IL, 60606, US

(73) Assignee: Computime, Ltd., Hong Kong (CN)

(21) Appl. No.: 11/692,503

(22) Filed: Mar. 28, 2007

(51) Int. Cl. G06F 7/04

(52) U.S. Cl. 726/17

(57) ABSTRACT

The present invention provides apparatuses and methods for providing security for a secured unit with a security code. The secured unit may be locked to prevent an unauthorized user from accessing the secured unit. In order to unlock the secured unit, a user enters a sequence of strokes through an input device, e.g., a circular input device. A security module extracts stroke information from the entered strokes and unlocks the secured unit when the extracted stroke information matches the security code. Stroke information may be indicative of the locations of the start and end points and the direction of each stroke. A security code is configured for a secured unit by a user entering a sequence of strokes through an input device. The security code is determined from stroke information. The stroke information may be verified by the user re-entering the sequence of strokes.

### FIELD OF THE INVENTION

The present invention relates generally to entering strokes through an input device, e.g., a circular input device in order to configure a security code and to unlock an apparatus.

### BACKGROUND OF THE INVENTION

Electronic equipment, e.g., MP3 players and wireless communication telephones, are becoming smaller with additional user capability. Electronic devices often have a circular input device for entering data into the electronic equipment but may not have a keypad because of size constraints. However, the user may wish to restrict use of the device to unauthorized users in order to protect important data, e.g., personal data.

Because of the need to reduce the size of an electronic device while increasing the capabilities of the electronic device, there is a real need in the marketplace to enable a user to ensure the security of the electronic device through a circular input device.

### SUMMARY OF THE INVENTION

The present invention provides apparatuses and methods and for providing security for a secured unit with a security code. The secured unit may be locked to prevent an unauthorized user from accessing the secured unit. In order to unlock the secured unit, a user enters a sequence of strokes through an input device, e.g., a circular input device. A security module extracts stroke information from the entered strokes and unlocks the secured unit when the extracted stroke information matches the security code.

With one aspect of the invention, a security module obtains the locations of the start point and an end point of an entered stroke when extracting stroke information for unlocking a secured unit. If the entered start or end points is sufficiently close to valid points, the security module determines that the entered points are valid points. The security module allows an acceptance range to be specified when approximating the start and end points.

With another aspect of the invention, direction information is obtained from an entered stroke when extracting stroke information. The locations of the start and end points may be used in conjunction with the direction data when comparing the stroke information with the security code.

With another aspect of the invention, one or more strokes may be entered when unlocking a secured unit. The number of strokes may be fixed or variable.

With another aspect of the invention, a security code is configured for a secured unit by a user entering a sequence of strokes through an input device. The security code is determined from stroke information. The stroke information may be verified by the user re-entering the sequence of strokes.

### BRIEF DESCRIPTION OF THE DRAWINGS

The foregoing summary of the invention, as well as the following detailed description of exemplary embodiments of the invention, is better understood when read in conjunction with the accompanying drawings, which are included by way of example, and not by way of limitation with regard to the claimed invention.

FIG. 1 shows a security module that inputs a sequence of strokes through a circular input device to lock or unlock an apparatus in accordance with an embodiment of the invention.

FIG. 2 shows a security module that inputs a sequence of strokes through a sliding input device to lock or unlock an apparatus in accordance with an embodiment of the invention.

FIG. 3 shows exemplary user scenarios for entering strokes through a circular input device in accordance with an embodiment of the invention.

FIG. 4 shows an approximation of a start point and an end point of an entered stroke through a circular input device in accordance with an embodiment of the invention.

FIG. 5 shows different directions of different strokes near the start point in accordance with an embodiment of the invention.

FIG. 6 shows different directions of different strokes near the end point in accordance with an embodiment of the invention.

FIG. 7 shows a flow diagram for processing security strokes to configure a security code in accordance with an embodiment of the invention.

FIG. 8 shows a flow diagram for processing unlocking strokes to unlock an apparatus in accordance with an embodiment of the invention.

FIG. 9 shows a flow diagram for processing security strokes to configure a security code in accordance with an embodiment of the invention.

FIG. 10 shows a circular input device in accordance with an embodiment of the invention.

FIG. 11 shows a flow diagram for determining a direction of an entered stroke in accordance with an embodiment of the invention.

FIG. 12 shows scenarios for extracting stroke information from entered strokes in accordance with an embodiment of the invention.

### DETAILED DESCRIPTION OF INVENTION

The following is separated by subheadings for the benefit of the reader. The subheadings include: Terms, Architecture of Platform, Exemplary Scenarios of Entering Strokes Through an Input Device, and Processing of Entered Strokes to Configure a Security Code and to Unlock an Apparatus.

### Terms

Stroke—a contiguous (uninterrupted) curve drawn on an input device, e.g., a circular input device. A start point is where the stroke begins and an endpoint is where the stroke ends. One or more security strokes are entered when a user is specifying a security code. One or more unlocking strokes are entered when a user is attempting to unlock an apparatus.

Stroke information—information that characterizes a stroke. Stroke information may include the locations of the start points and the end points and the direction of the stroke.

Security code—collection of information that stroke must match to unlock an apparatus. A security code may include information that is extracted from a sequence of security strokes.

### Architecture of Platform

Embodiments of the invention enable a user to enter strokes through an input device in order to configure a security code and to unlock an apparatus.

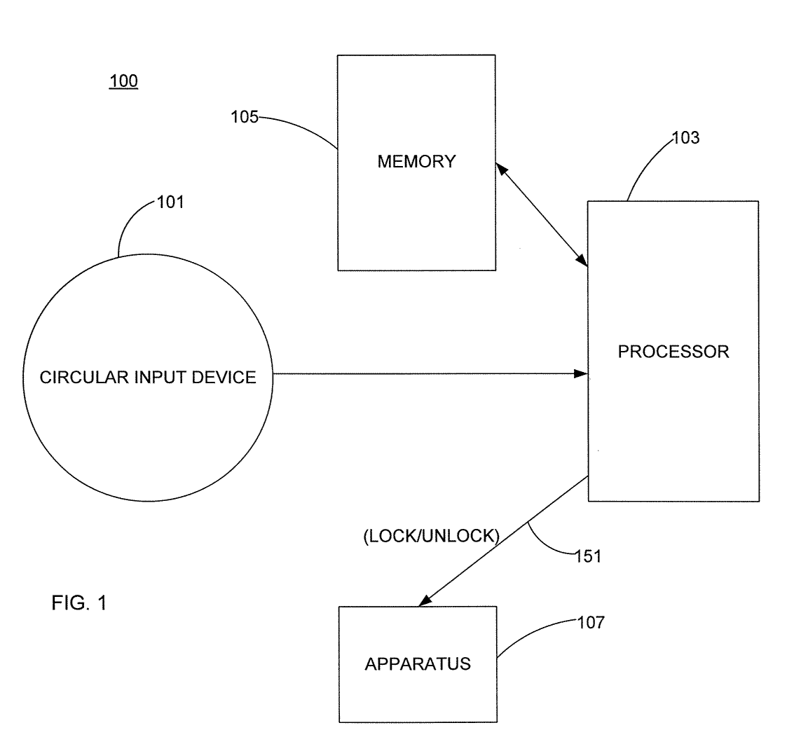

FIG. 1 shows security module 100 that inputs a sequence of strokes through a circular input device 101 to lock or unlock apparatus 107 in accordance with an embodiment of the invention. Security module 100 may be contained in apparatus 107 (e.g., a MP3 player) or may external to apparatus 107 (e.g., a door latch). Security module 100 may be incorporated with different products. For example, a user may have data on a portable computer that must be protected while the user is not present. As another example, a parent wishes to prevent a child from opening a car door or a refrigerator door or turning on an electrical appliance by using a child proof lock for safety reasons.

Security module 100 includes circular input device 101 for a user to enter one or more strokes (a sequence of strokes) to configure a security code and to subsequently unlock apparatus 107 by entering a sequence of unlocking strokes. Processor 103 processes entered strokes to determine the security code and to determine whether information from entered strokes match the security code. Processor 103 may store the security code and stroke information in memory 105.

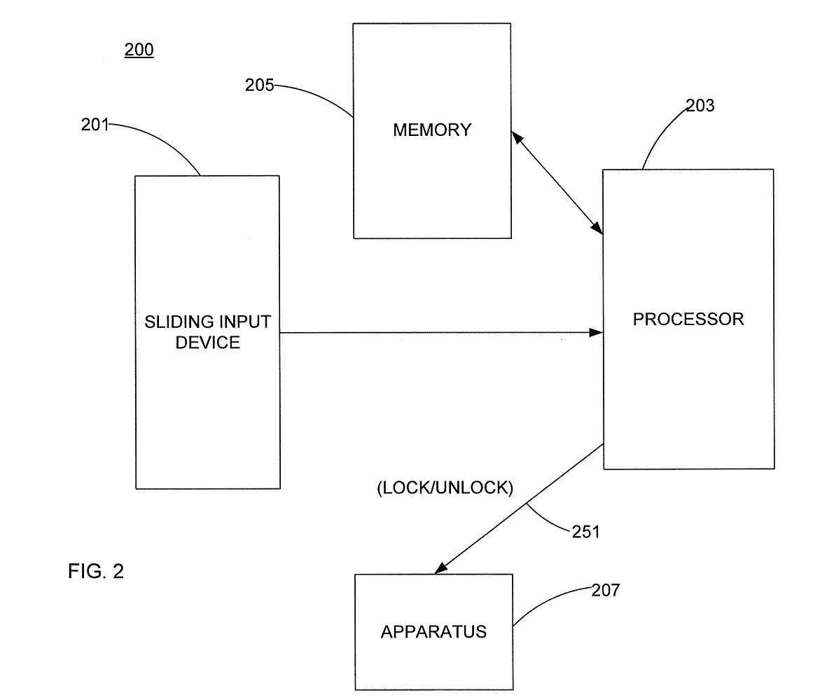

FIG. 2 shows security module 200 that inputs a sequence of strokes through sliding input device 201 to lock or unlock an apparatus 207 in accordance with an embodiment of the invention. Security module 200 includes sliding input device 201 for a user to enter one or more strokes (a sequence of strokes) to configure a security code and to subsequently unlock apparatus 207 by entering a sequence of unlocking strokes. Processor 203 processes entered strokes to determine the security code and to determine whether information from the entered strokes match the security code. Processor 203 may store the security code and stroke information in memory 205.

Exemplary Scenarios of Entering Strokes through an Input Device

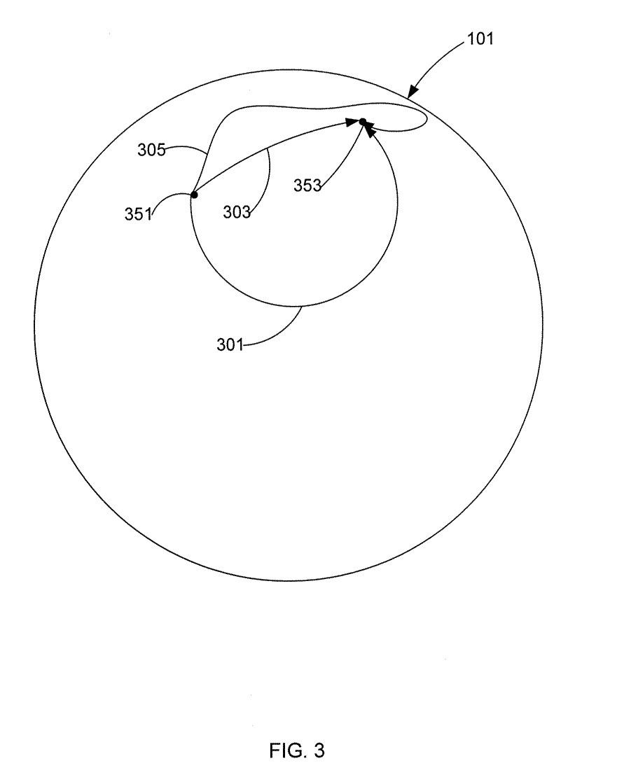

FIG. 3 shows exemplary user scenarios for entering strokes 301, 303, and 305 through circular input device 101 in accordance with an embodiment of the invention. Each stroke has start point 351, where a user starts to apply pressure (touch) to circular input device 101, and end point 353, where the user releases pressure to circular input device 101.

While different strokes typically have different start points and end points, FIG. 3 illustrates a situation in which different strokes have the same start point (e.g., start point 351) and/or the same end point (e.g., end point 353). In such cases, embodiments of the invention may utilize additional stroke information (e.g., direction information) as will be discussed.

Strokes may be entered to configure a security code as will be discussed. In such cases, associated strokes are referred as security strokes. Also, strokes may be entered to unlock an apparatus, where associated information is matched to the security code. In such cases, associated strokes are referred as unlocking strokes.

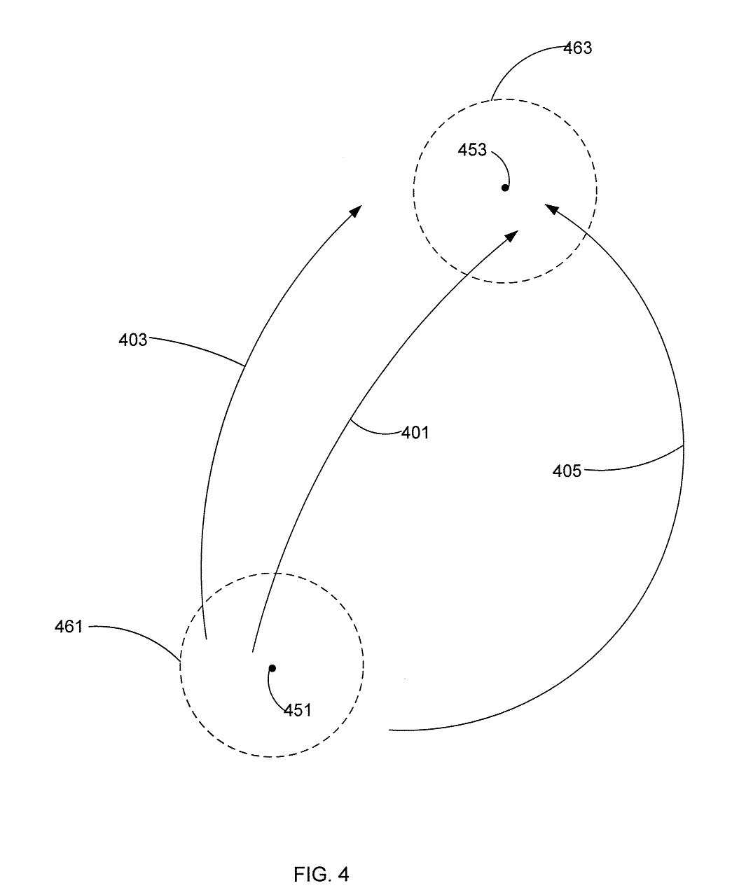

FIG. 4 shows an approximation of start point 451 and end point 453 of an entered stroke (e.g., 401 and 403) through circular input device 101 in accordance with an embodiment of the invention. Typically, a user cannot exactly enter the same stroke when repeating an operation. Consequently, start points and end points of different strokes (that are intended to be the same by the user) are not exactly the same.

In the example shown in FIG. 4, the user attempts to enter strokes 401 and 403 so that both strokes have start point 451 and end point 453. However, strokes 401 and 403 do not have start points and end points that are exactly the same as start point 451 and end point 453. Consequently, embodiments of the invention may support an approximation of a start point and an end point, where the points are considered to be the same as the desired points if the entered points are sufficiently close to the desired points. For example, if the actual start point of an entered stroke is within circle 461 (having a center corresponding to start point 451), then the actual start point is considered to be the same as desired start point 451. Similarly, if the actual end point of an entered stroke is within circle 463 (having a center corresponding to end point 453), then the actual end point is considered to be the same as desired end point 453. As shown in the example in FIG. 4, the start and end points of stroke 401 are approximated as being start points 451 and 453, respectively. However, the end point of stroke 403 is not considered as being end point 453 since the end point is outside the circle of tolerance.

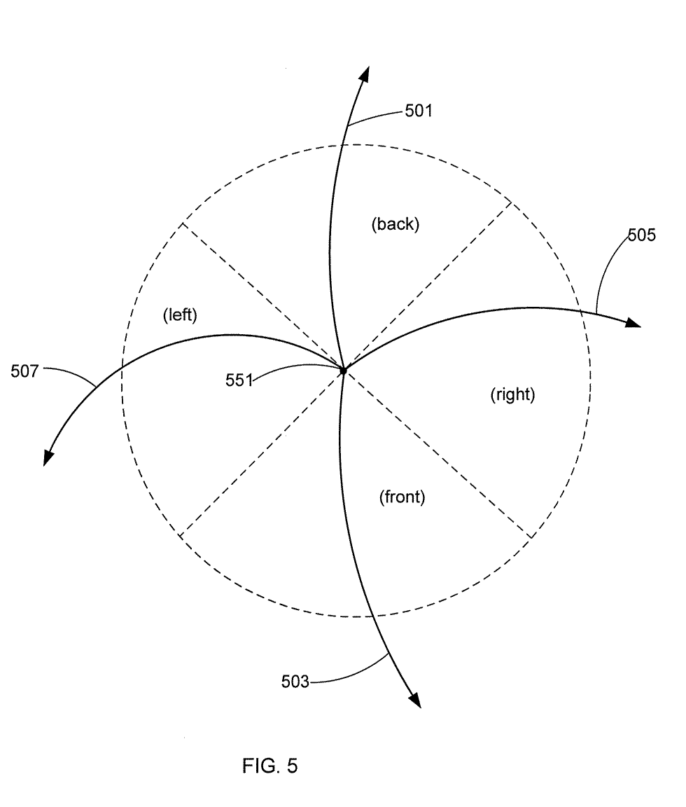

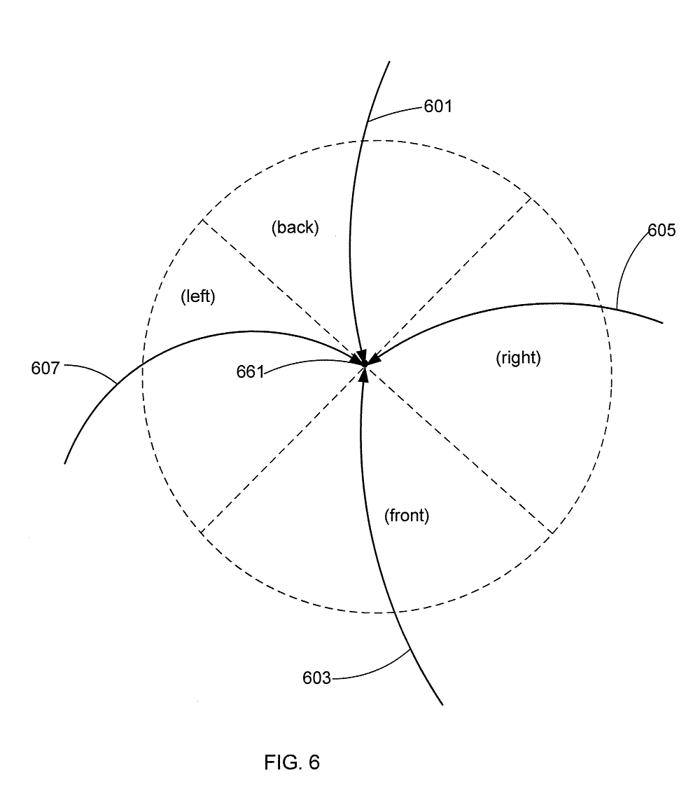

FIG. 5 shows different directions of different strokes 501-507 near start point 551 in accordance with an embodiment of the invention. With embodiments of the invention, stroke information that is extracted from an entered stroke may include direction information. For example, the directions of strokes 501, 503, 505, 507 are back, front, right, and left, respectively, near start point 551. Similarly, FIG. 6 shows different directions of different strokes 601-607 near end point 661 in accordance with an embodiment of the invention. The directions of strokes 601, 603, 605, 607 are back, front, right, and left, respectively, near end point 651. Direction information for a stroke may include the directions of the stroke near the start point and the end point. However, embodiments of the invention may use other attributes to extract direction information for a stroke. For example, direction information may be indicative whether a stroke traverses in a clockwise or counterclockwise (anti-clockwise) direction about the center of circular device 101.

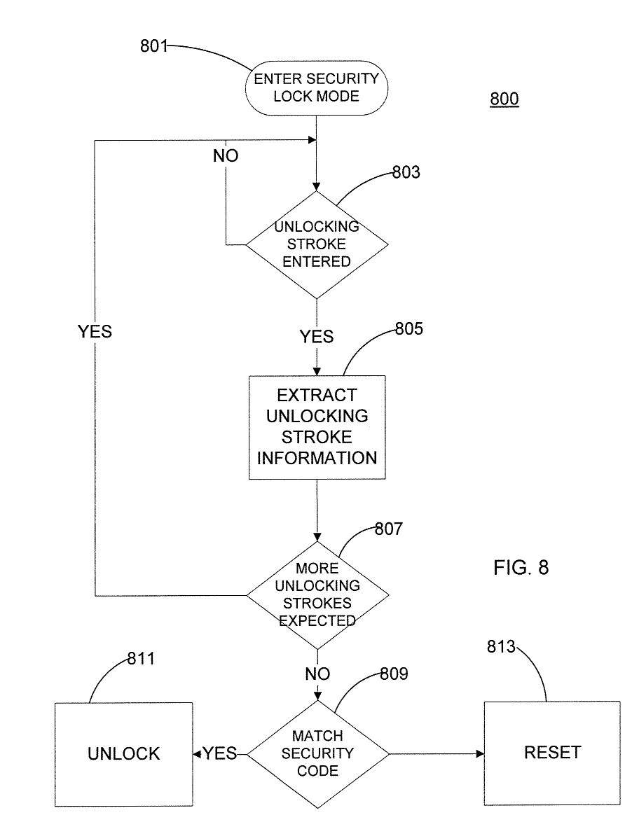

Stroke information that is extracted from a sequence of security strokes can be used as a security code for locking an apparatus as will be further discussed with FIGS. 6 and 8. Consequently, with embodiments of the invention, a security code is not a fixed sequence of key inputs but a sequence of use-entered input strokes. The start point, end point, and direction of the each stroke may be varied. The security module (e.g., module 100 or 200) can capture the approximate start and end points to form security code from a sequence of fixed number of strokes (e.g., three or four) or a variable number of strokes (e.g., from two to six strokes). As an example, if three strokes are used to configure the security code, the security code may be represented as a set of information comprising {start point i, end point i, direction i, start point 2, end point 2, direction 2, start point 3, end point 3, direction 3}.

Similarly, to unlock an apparatus, stroke information may be extracted from unlocking strokes as will be further discussed with FIG. 8. If the extracted stroke information matches the security code, the security module instructs the apparatus to unlock.

### Processing of Entered Strokes to Configure a Security Code and to Unlock an Apparatus

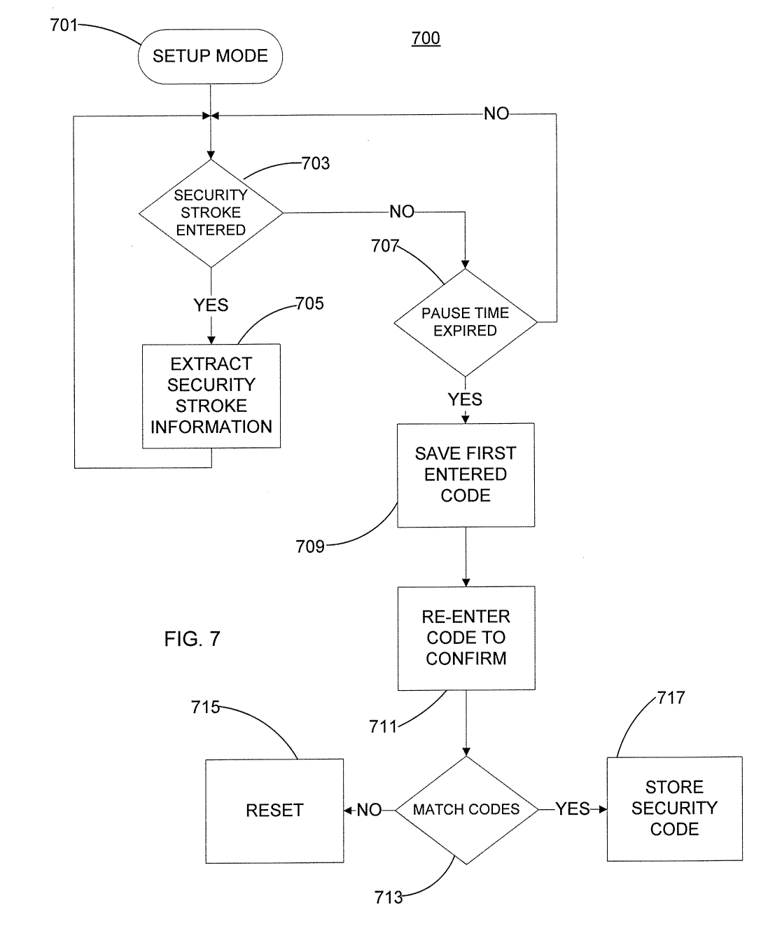

FIG. 7 shows flow diagram 700 for processing security strokes to configure a security code in accordance with an embodiment of the invention. The setup of the security lock may be through a menu displayed on a user interface. Once the setup mode is entered in step 701, the security module waits for a user to input a sequence of security strokes. Once the user starts to touch the input device, the security module learns the approximate start location and end location together with the direction. In steps 703 and 705, the user enters the sequence of security strokes from which stroke information is extracted. The approximation of the locations of the start point and the end point can be determined by the programmer or end user. For example, entered points may be ±1 cm or ±2 cm from the learned location.

In step 707, if pause time has not expired, process 700 will continue to scan for further entered strokes in order to configure the security code. However, if the pause time expires, process 700 will save the extracted stroke information as being potentially the security code in step 709.

In step 711, the user re-enters the sequence of entered strokes as was entered in steps 703-707. Re-entered code information is approximated within the specified tolerances. If the re-entered code matches the originally-entered code, as determined by step 713, the security code is set to the entered code. The security code is stored in memory (e.g., memory 105, for later retrieval when a user is attempting to unlock the apparatus. However, if the codes do not match, process 700 is reset so that the user needs to repeat process 700 in order to configure the security code.

Once the security code has been configured, the apparatus may enter the security lock mode in order to provide a security lock or a child-proof lock. Embodiments of the invention support different methods to activate the security lock mode. For example, a user may:
setup a preset time through a menu, in which the security module activates the security lock mode when the timer expires because of user inactivity
press a designated button to activate the security lock mode
enter the security mode through a menu
enter a predefined sequence of strokes through an input device to enter the security lock

FIG. 8 shows flow diagram 800 for processing unlocking strokes to unlock an apparatus in accordance with an embodiment of the invention. In step 801, the security module enters a security lock mode, in which the apparatus is non-responsive until the user enters the security code. With embodiments of the invention, the user may unlock the apparatus by pressing a designated button (e.g., a child-proof lock). Alternatively, the user may enter a sequence of unlocking strokes through an input device. The security module processes the entered strokes as shown in flow diagram 800.

In steps 803-807, user enters strokes in an attempt to unlock the apparatus. The security module extracts stroke information in step 805 for each entered unlocking stroke. When all of the strokes have been entered, as determined by step 807, the security module determines if the extracted stroke information matches the security module. The security module may require an exact match or may require a sufficient number of stroke attributes to match the security code. If the extracted stroke information matches the security code, as determined by step 809, the apparatus is unlocked in step 811. Otherwise, the process 800 resets in step 813, and the user must repeat the process in order to attempt unlocking the apparatus.

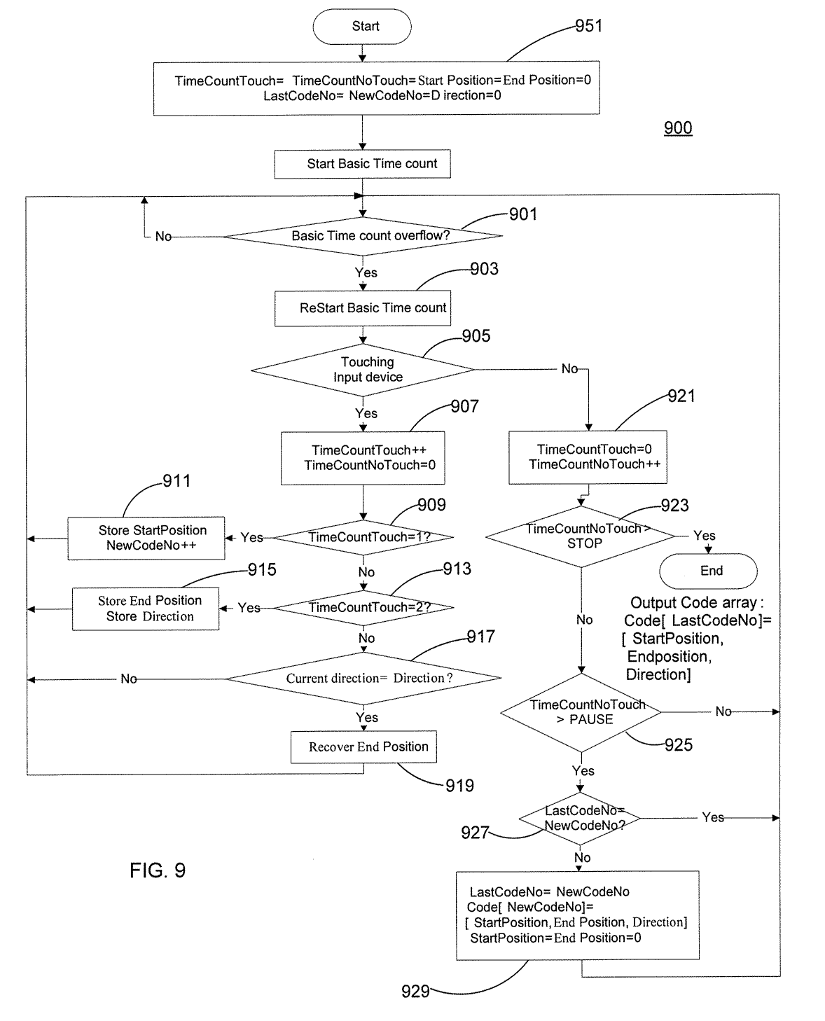

FIG. 9 shows flow diagram 900 for processing security strokes to configure a security code in accordance with an embodiment of the invention. (Please note that flow diagram 700 provides a similar process for configuring a security code.) Initially, timers and location registers are reset in step 951. Process 900 periodically scans activity on a circular input device in accordance with basic time overflow in step 901. When the basic timer expires, the timer is reset in step 903, and the security module determines if the input device is being touched in step 905.

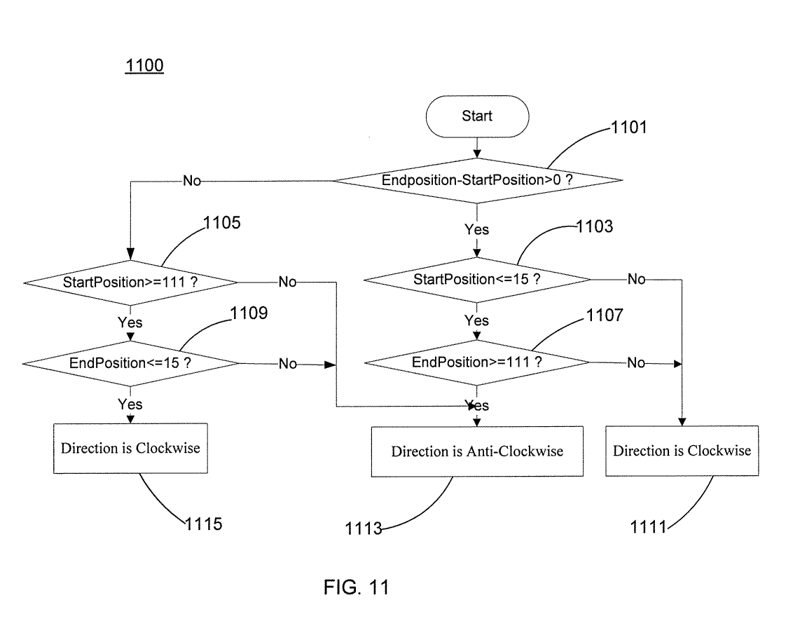

If the input device is being touched, steps 907-919 are executed to extract stroke information from the entered stroke. In step 917 direction information is extracted from the entered stroke as will be further discussed in FIG. 11.

Once the user terminates touching the input device to specify the entered stroke, as determined by step 905, process 900 determines if additional strokes may occur to obtain additional stroke information from subsequent strokes in steps 921-925. If step 927 determines that a new security code has been configured, the new security code is entered into memory in step 929. The security code comprises an array, where each member of the array corresponds to the locations of the start point and end point and the direction of each stroke.

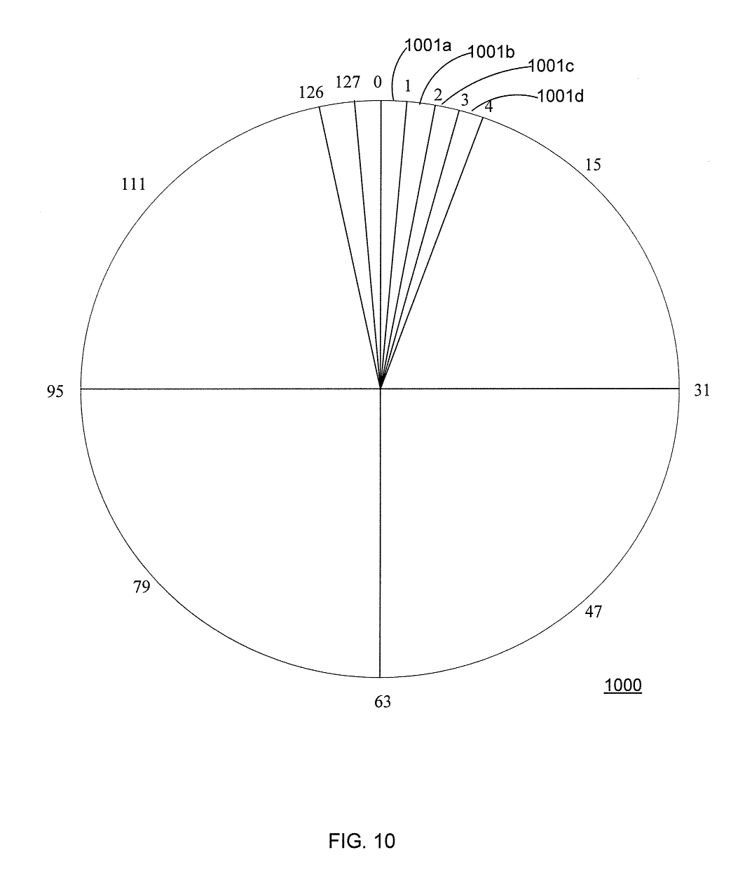

FIG. 10 shows circular input device 1000 in accordance with an embodiment of the invention. The touch screen is divided into 128 equal radial sections, in which each region, (e.g. sections 1001a-1001d) is assigned a section number (1-128). If a point (either a start point or an end point of an entered stroke) is located anywhere in a region, the location of the point is associated with assigned section number of the region.

FIG. 11 shows flow diagram 1100 for determining a direction of an entered stroke in accordance with an embodiment of the invention. The exemplary embodiment shown in process 1100 refers to the section number assignments that are shown in FIG. 10. Steps 1101-1109 analyze the locations (positions) of the start point and end point of the entered stroke. (Please note that an entered stroke may refer to either a security stroke or an unlocking stroke.) The direction of the stroke is determined in steps 1111-1115, where the direction may be either clockwise or anti-clockwise (counterclockwise).

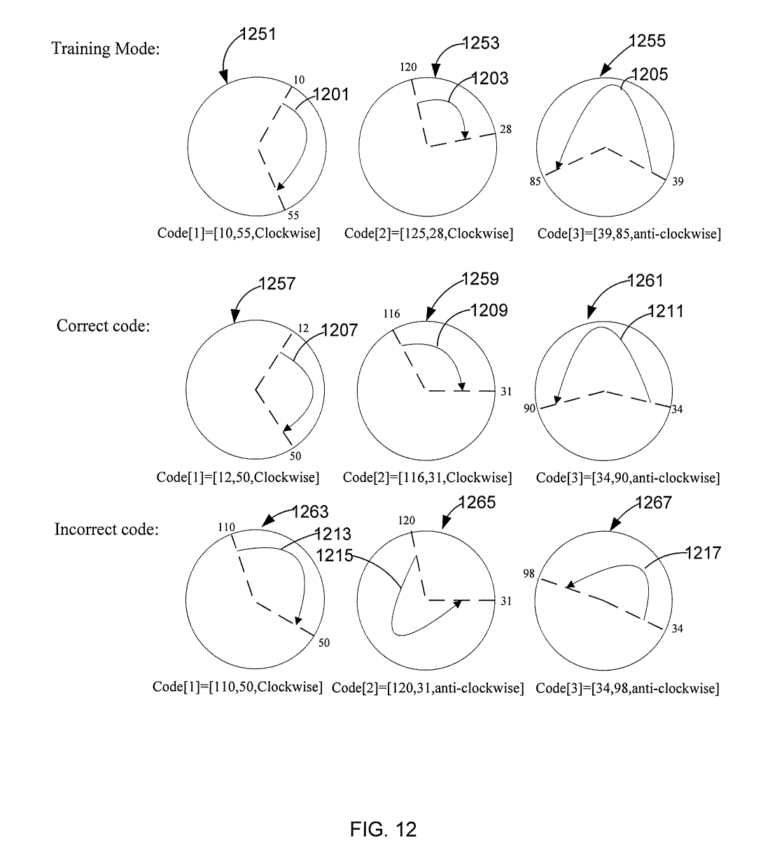

FIG. 12 shows scenarios 1251-1267 for extracting stroke information from entered strokes in accordance with an embodiment of the invention. Scenarios 1251-1255 (corresponding to strokes 1201-1205, respectively) correspond to a training process, in which a user enters security strokes during the setup mode. A security module extracts security stroke information when configuring a security code. In the exemplary example, the security code configured to be {10, 55, clockwise; 125, 28, clockwise; 39, 85, anti-clockwise}. When a user subsequently attempts to unlock the device, the unlocking stroke information must match the security code within predetermined precision limits (e.g., ±5 units). Thus, when the user sequentially executes scenarios 1257-1261, the device will be unlocked. However, when the user sequentially executes scenarios 1263-1267, the device will remain locked.

As can be appreciated by one skilled in the art, a computer system with an associated computer-readable medium containing instructions for controlling the computer system can be utilized to implement the exemplary embodiments that are disclosed herein. The computer system may include at least one computer such as a microprocessor, digital signal processor, and associated peripheral electronic circuitry.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for providing security for an apparatus, comprising:
(a) locking the apparatus to prevent an unauthorized user from accessing the apparatus;
(b) detecting an unlocking stroke that is entered though an input device;
(c) extracting unlocking stroke information from the unlocking stroke;
(d) repeating (b)-(c) when another unlocking stroke is entered; and
(e) when the unlocking stroke information matches a security code, unlocking the apparatus to enable an authorized user to access the apparatus.

2. The method of claim 1, (c) comprising:
(c)(i) obtaining an entered start point location and an entered end point location of the unlocking stroke.

3. The method of claim 2, (c) further comprising:
(c)(ii) determining whether the entered start point location is sufficiently close to a valid start point location; and
(c)(iii) determining whether the entered end point location is sufficiently close to a valid end point location.

4. The method of claim 3, wherein
(c)(ii) comprises:
(c)(ii)(1) measuring a start distance between the entered start point location and the valid start point location; and
(c)(ii)(2) determining whether the start distance is within a predetermined start limit; and
(c)(iii) comprises:
(c)(iii)(1) measuring an end distance between the entered end point location and the valid end point location; and
(c)(iii)(2) determining whether the end distance is within a predetermined end limit.

5. The method of claim 2, (c) further comprising:
(c)(ii) obtaining direction information associated with the unlocking stroke.

6. The method of claim 1, (e) comprising:
(e)(i) verifying that the unlocking stroke information is the same as the security code for all unlocking strokes.

7. The method of claim 1, further comprising:
(f) storing the unlocking information in memory for subsequent retrieval.

8. The method of claim 1, further comprising:
(f) retrieving the security code from memory.

9. The method of claim 1, further comprising:
(f) determining a number of expected unlocking strokes associated with unlocking the apparatus.

10. The method of claim 1, (a) comprising:
(a)(i) locking the apparatus when a predetermined time is exceeded.

11. The method of claim 1, (a) comprising:
(a)(i) locking the apparatus when a predetermined sequence of entered stroke is entered.

12. A method for providing security for an apparatus, comprising:
(a) detecting a setup mode that allows an authorized user to enter a security code;
(b) detecting a security stroke that is entered through an input device;
(c) extracting security stroke information from the security stroke;
(d) repeating (b)-(c) when another security stroke is entered;
(e) determining a security code from the security stroke information; and
(f) locking the apparatus to prevent an unauthorized user from accessing the apparatus based on the security code.

13. The method of claim 12, further comprising:
(g) verifying the security stroke information.

14. The method of claim 13, (g) comprising:
(g)(i) repeating (b)-(e); and
(g)(ii) comparing the security stroke information with re-entered security stroke information.

15. The method of claim 12, (c) comprising:
(c)(i) obtaining a start point location and an end point location of the security stroke.

16. The method of claim 15, (c) further comprising:
(c)(ii) obtaining direction information associated with the security stroke.

17. The method of claim 12, further comprising:
(g) unlocking the apparatus by processing a sequence of entered strokes.

18. The method of claim 12, further comprising:
(g) unlocking the apparatus by detecting a user pressing a designated button.

19. The method of claim 17, further comprising:
(h) obtaining a predetermined approximation limit for processing the sequence of entered strokes to determine whether to unlock the apparatus.

20. A security module for providing security for an apparatus, comprising:
an input device capturing input stroke information; and
a processing unit obtaining the input stroke information from the input device and configured to perform:
(a) locking the apparatus to prevent an unauthorized user from accessing the apparatus based on a security code;
(b) detecting an unlocking stroke that is entered though the input device;
(c) extracting unlocking stroke information from the unlocking stroke;
(d) repeating (b)-(c) when another unlocking stroke is entered; and
(e) when the unlocking stroke matches a security code, unlocking the apparatus to enable an authorized user to access the apparatus.

21. The security module of claim 20, the processing unit being further configured to perform:
(f) detecting a setup mode that allows an authorized user to enter a security code;
(g) detecting a security stroke that is entered through the input device;
(h) extracting security stroke information from the security stroke;
(i) repeating (g)-(h) when another security stroke is entered; and
(j) determining the security code from the security stroke information.
